(19) United States
(12) Patent Application Publication
(10) Pub. No.: US 2006/0044972 A1
(43) Pub. Date: Mar. 2, 2006

(54) Method and apparatus for optical disc PCA search

(75) Inventor: Jee-hyung Park, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/193,480

(22) Filed: Aug. 1, 2005

(30) Foreign Application Priority Data
Aug. 13, 2004 (KR) 2004-63708

(51) Int. Cl. G11B 5/09

(52) U.S. Cl. 369/47.55; 369/53.1

(57) ABSTRACT

Disclosed is a method for searching a boundary point between at least one recordable area for recording data and at least one non-recordable area of a Power Calibration Area (PCA) in an optical disc. According to the method, an optical disc drive moves to a first point in the PCA, and checks whether the first point is a recordable or a non-recordable area. Then, based on a result of the checking, the optical disc drive moves to the right or left for a second point located in a first-designated space that varies by movement count, and checks whether the second point is a recordable area or a non-recordable area. Thereafter, the optical disc drive repeats the moving and checking operation until a first non-recordable area adjacent to the recordable area is searched. In this manner, the drive can quickly search the boundary point between recordable areas and non-recordable areas.

### CROSS-REFERENCE TO RELATED APPLICATION

This application claims the benefit of Korean Patent Application No. 2004-63708, filed on Aug. 13, 2004, the entire content of which is incorporated herein by reference.

### BACKGROUND OF THE INVENTION

1. Field of the Invention

The present invention relates in general to a Power Calibration Area (PCA) of an optical disc, being divided into recordable areas and non-recordable (read-only) areas. More specifically, embodiments of the present invention relate to methods and apparatus for identifying an address of a boundary point (or division point) between the recordable areas and the non-recordable areas.

2. Description of the Related Art

Ever since optical discs were commercialized in 1982, the fabrication technologies of discs have been steadily advanced. Short laser wavelengths for semiconductors, thin-film substrates, and higher numerical apertures (NA) of objective lenses are only a few examples of what has been achieved. Technical advances in disc fabrication technologies and rapid technical development in encoding moving pictures has brought the mass production of interactive video technology.

An optical disc has a dual-layered structure formed of a silvery aluminum reflective layer and a protective layer. The aluminum reflective layer has a pit, and a track is formed along the pit. A head of an optical disc drive (hereinafter it will be referred to simply as drive) rotates the track along the pit, and reads data using a laser beam reflected from the surface of the optical disc. For the head to be able to read data from the optical disc, the drive rotates at a designated speed.

In detail, the drive emits laser beams towards pits and lands on the disc, and reads data using the difference of reflectance of the emitted laser beams. Here, a device for emitting laser beams is called a laser diode. The laser diode is focused into a small circle through a lens, and transmits laser beams onto the surface of the optical disc. A photo detector detects or senses reflective laser beams from the optical disc.

FIG. 1 is a schematic representation of a conventional optical disc. As shown in FIG. 1, the optical disc is largely divided into a Power Calibration Area (PCA) for use in searching an optimum record laser power, a Recording Information Area (RIA) including a Recording Management Area (RMA), and an information area. The information area is sub-divided into a lead-in area, a data recordable area, and a lead-out area. The RIA area will be described in greater detail below.

The PCA is located near the center of the optical disc. When the recorder records data, it uses the PCA to identify an optimum laser power according to characteristics of the optical disc. To record more data on the optical disc, the recorder must adjust the amount of power to an optimum level, namely, Optimum Power Calibration (OPC). By performing the OPC, an optimum laser power is determined.

The OPC should be performed first on the optical disc because laser power levels to record the data are set differently for each optical disc medium. In other words, although optical discs are manufactured using the same procedure, set noises and differences in disc mediums lessen the probability of manufacturing exactly the same optical discs. This phenomenon is more evident as between different manufactures of optical discs. For this reason, a different level of laser power by the optical disc medium is emitted to record the data on the optical disc.

Using the variable laser power, the drive repeats the record and read processes onto and from the PCA. When the data recorded on the PCA is read without any error, the drive stops the data write and read processes. The drive recognizes the laser power used for recording the data that has been read without an error as an optimum laser power, and utilizes it whenever the data needs to be recorded on the data recordable area.

The RMA area is used for temporarily recording a table of contents (TOC) information (information on track number, and a beginning and an end of the information). When the session is terminated, the information temporarily recorded on the RMA area is transferred to the lead in area of each session.

FIG. 2 is a diagram explaining how to search for and identify a boundary point between the recordable areas and the non-recordable areas in a PCA according to a conventional method. As shown in FIG. 2, the PCA area is divided into the recordable areas and the non-recordable areas. The recordable areas are areas where (arbitrary) data is already recorded following the OPC process, whereas the non-recordable areas are areas where no data is recorded thereon. As a rule, the drive starts the OPC from an address (identifier) corresponding to a boundary point between the recordable areas and the non-recordable areas. Hereinafter, the terms address and identifier will be used interchangeably.

Each area in the PCA has its own address. For instance, the areas shown in FIG. 2 are allocated with 00000 to 11111 as their addresses, respectively. Usually, the drive performs the OPC in reverse order of the addresses. That is, the drive starts the first OPC in the area having the address 11111. Also, to more effectively use the PCA, the drive performs the OPC on the non-recordable areas with high addresses first.

The recordable areas in FIG. 2 are allocated with addresses 10110 to 11111, and the non-recordable areas are allocated with addresses 00000 to 10101. In order to search the non-recordable areas, the drive checks the PCA sequentially in reverse order, starting from the area having the address 11111. As aforementioned, since the area having the address 11111 is a recordable area, the drive moves to an area having the address 11110 next and checks if the area is a recordable or a non-recordable area. According to FIG. 2, the area having the address 11110 is also a recordable area. The drive repeats the above-described procedure until it searches a non-recordable area. That is to say, referring to FIG. 2, the drive repeats the procedure until it checks the area having the address 10101 (which is a first non-recordable area next to the recordable area).

Although the drive managed to find the area with the address 10101 and recognize it as the non-recordable area, it was only after spending much time searching for the boundary point between the recordable areas and the non-recordable areas. Therefore, there is a need to develop a method for quickly searching for and identifying the boundary between the recordable areas and the non-recordable areas.

### SUMMARY OF THE INVENTION

It is, therefore, an aspect of the present invention to provide a method for quickly searching an address or an identifier corresponding to a boundary point between recordable areas and non-recordable areas in a PCA of an optical disc, or an address of a first non-recordable area adjacent to recordable areas.

Another aspect of the present invention is to provide a method for cutting the time spent loading of an optical disc, by quickly searching an address or an identifier corresponding to a boundary point, or an address of a first non-recordable area adjacent to recordable areas.

To achieve the above aspects and advantages, there is provided a method for searching a boundary point between at least one recordable area for recording data and at least one non-recordable area of a PCA (Power Calibration Area) in an optical disc, the method including, in an optical disc drive, moving to a first point in the PCA, and checking whether the first point is a recordable or a non-recordable area; in the optical disc drive, based on a result of the checking, moving to the right or left for a second point located in a first-designated space that varies by movement count, and checking whether the second point is a recordable area or a non-recordable area; and in the optical disc drive, repeating the moving and checking until a first non-recordable area adjacent to the recordable area is searched.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic representation of a conventional optical disc;

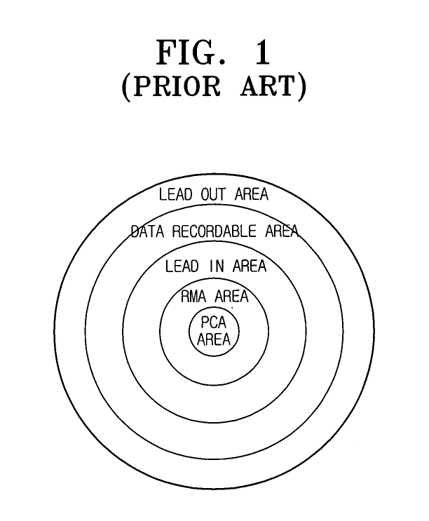

FIG. 2 is a diagram explaining how to identify a boundary point between recordable areas and non-recordable areas in a PCA, in accordance with a conventional method;

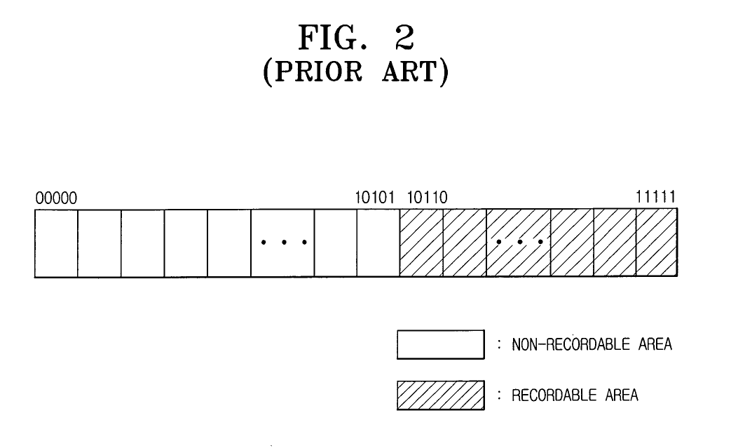

FIG. 3 is a flow chart of a method for identifying an address (identifier) of a boundary point between recordable areas and non-recordable areas in a PCA of an optical disc, in accordance with one embodiment of the present invention;

FIG. 4 is a diagram explaining how to identify a boundary point between recordable areas and non-recordable areas in a PCA, in accordance with the present invention; and

FIG. 5 is a flow chart of a method for identifying an address (identifier) of a boundary point between recordable areas and non-recordable areas in a PCA of an optical disc, in accordance with another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

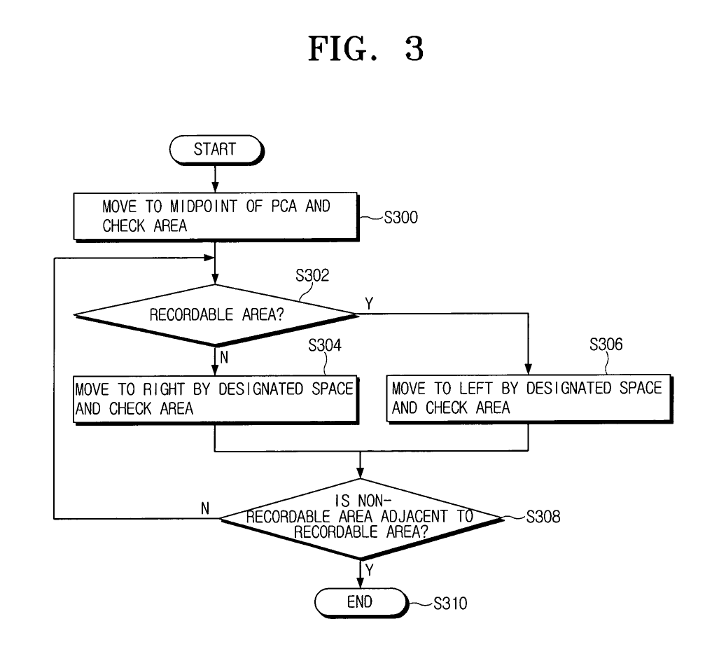

FIG. 3 is a flow chart of a method for identifying a boundary point between recordable areas and non-recordable areas in a drive, in accordance with an embodiment of the present invention. The following will now describe in greater detail how to search for and identify an address corresponding to a boundary point between recordable areas and non-recordable areas in a PCA, or an address corresponding to a first non-recordable area adjacent to recordable areas. To this end, an embodiment of the present invention suggests a method for searching for and identifying non-recordable areas by designated space (address space), instead of searching non-recordable areas sequentially starting from a specific area as in the related art. Here, the designated space is changed by search count (or movement count). For the sake of convenience of explanation in relation to FIG. 3, it is assumed that each area in the PCA has an address allocated in sequence. For instance, it is assumed that areas with lower addresses are located on the inner side of an optical disc, whereas areas with higher addresses are located on the outer side of the optical disc.

In operation S300, the drive moves to an address corresponding to a mid (½) point of a PCA of the drive, and checks the area on that spot. In operation S302, the drive decides whether the midpoint is a recordable area or a non-recordable area. If it turns out that the midpoint is a recordable area, the drive proceeds to operation S306, and if not, the drive proceeds to operation S304.

In operation S304, the drive moves to the right (outward) by the designated space (to be described below), and checks an area. In operation S306, the drive moves to the left (inward) by the designated space, and checks an area. In operation S308, the drive decides whether the area it moved to is adjacent to a recordable area and a non-recordable area. If the non-recordable area is adjacent to a recordable area, the drive proceeds to operation S310 and ends the procedure. However, if the area is not adjacent to both of the areas (i.e. not next to a boundary area or point), the drive proceeds to operation S302.

The designated space will now be explained in detail. According to the procedure explained in FIG. 3, the drive starts its checking process, starting from an address corresponding to a midpoint of the PCA. Then, the drive moves to the right or left from the first checking point by a ¼ length of the PCA (length), and performs the second checking process. Similarly, the drive moves to the right or left from the second checking point by a ⅛ length of the PCA (length), and performs the third checking process. These processes are continued in sequence until the drive acquires an address of a boundary point between the recordable areas and the non-recordable areas. Moreover, the drive acquires an address of the first non-recordable area. Although in FIG. 3 the drive moves to an area by specific length and then checks the area, it is more preferable that the drive moves to a specific address and then checks an area with the specific address.

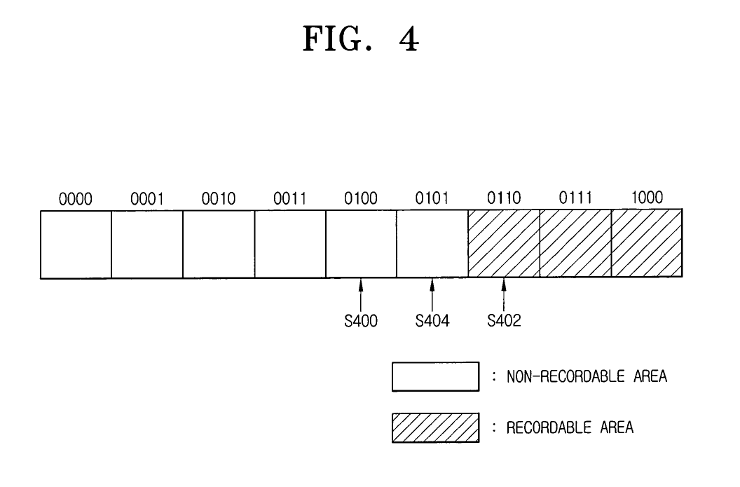

The following will now describe a method for identifying a boundary point between recordable areas and non-recordable areas in a PCA, in reference to FIG. 4.

For the sake of convenience of explanation, a PCA area shown in FIG. 4 is divided into 8 areas. Each area has its own unique address. That is, addresses 0000 to 1000 are allocated to the areas, respectively.

In operation S400, the drive moves to an area having an address 0100, and checks whether the area is a recordable area or a non-recordable area. According to FIG. 4, since the area having the address 0100 is a non-recordable area, the drive confirms that the area having the address 0100 is a non-recordable area. Therefore, the drive moves to a mid (½)-point between an area having the address 0100 and an area having the address 1000.

In operation S402, the drive moves to an area having the address 0110, and checks whether the area is a recordable area or a non-recordable area. According to FIG. 4, since the area having the address 0110 is a recordable area, the drive confirms that the area having the address 0110 is a recordable area. Therefore, the drive moves to a mid (½)-point between an area having the address 0100 and an area having the address 0110.

That is, the drive moves to an area having the address 0101 as shown in S404, and checks whether the area is a recordable area or a non-recordable area. According to FIG. 4, since the address having the address 0101 is a non-recordable area, the drive confirms that the area having the address 0101 is a non-recordable area.

At the same time, the drive recognizes that the area with the address 0101 and the area with the address 0110 are adjacent to each other. Therefore, the drive recognizes that the area with the address 0101 is the first non-recordable area in reverse order. If necessary, the drive performs the OPC sequentially, starting from the area with the address 0101.

Therefore, when the PCA is divided into 8 areas as in FIG. 4, it took three sequential checking processes for the drive to search the address of the boundary point between the recordable areas and the non-recordable areas, and the address of the first starting non-recordable area. In other words, if the number of divided areas of the PCA is increased, the checking count (the number of checking processes to be performed) is also increased.

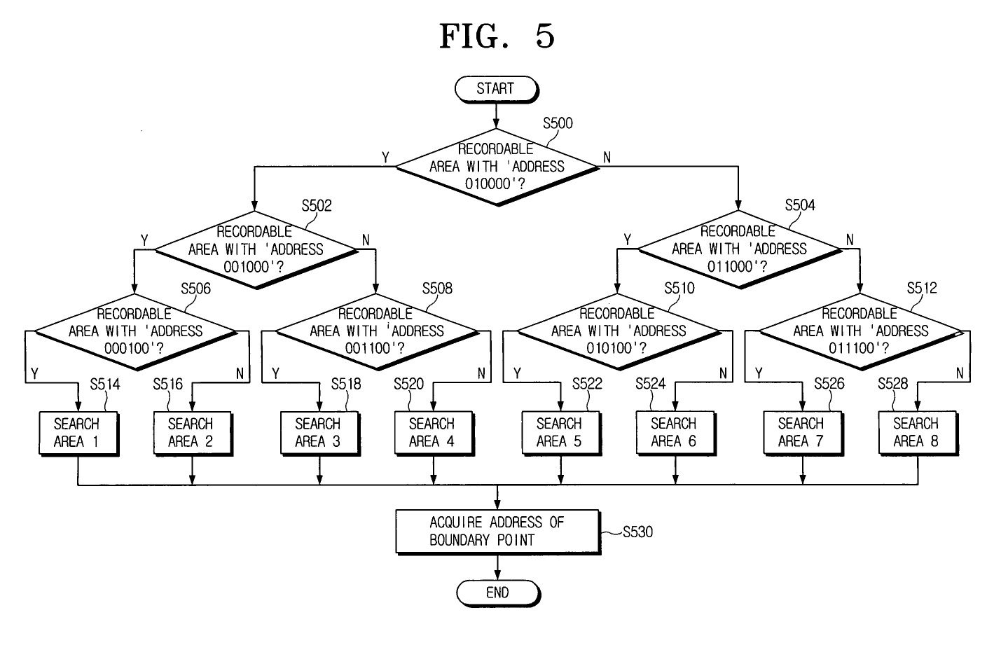

According to another embodiment, however, instead of repeating the checking processes until the boundary point between the recordable areas and the non-recordable areas is identified, the drive can perform the checking processes only for a predetermined number of times. By checking limited areas only for the predetermined number of time, the drive can acquire information on the boundary point. This method will now be explained in greater detail with reference to FIG. 5.

For better understanding of the method in FIG. 5, one should know that a PCA may be divided into 32 areas. Of course, the 32 areas have their own unique addresses from 000000 to 100000, respectively.

Suppose that the drive is to perform the checking process three times. In operation S500, the drive moves to an area having the address 010000. The drive performs the first checking process on the area having the address 010000, and checks whether it is a recordable area or a non-recordable area. If the area turns out to be a recordable area, the drive proceeds to operation S502 to perform the second checking process on an area having the address 001000. If the area having the address 01000 is a non-recordable area, the drive proceeds to operation S504 and performs the second checking process on an area having the address 011000.

In operation S502, the drive checks whether the area having the address 001000 is a recordable area or a non-recordable area. If the area with the address 001000 is a recordable area, the drive proceeds to operation S506 and performs the third checking process on an area having the address 000100. If the area with the address 000100 is a recordable area, the drive proceeds to operation S514 and searches a first area. If the area with the address 000100 turns out to be a non-recordable area after the third checking process, the drive proceeds to operation S516 and searches a second area.

If the area with the address 001000 is a non-recordable area, the drive proceeds to operation S508, in which the drive moves to an area with the address 001100 for performing the third checking processing thereon. If the area having the address 001100 turns out to be a recordable area after the third checking process, the drive proceeds to operation S518 and searches a third area. On the other hand, if the area having the address 001100 turns out to be a non-recordable area after the third checking process, the drive proceeds to operation S520 and searches a fourth area.

In operation S504, the drive performs the second checking process to check whether the area having the address 011000 is a recordable area or a non-recordable area. If the area with the address 011000 is a recordable area, the drive proceeds to operation S510, in which the drive moves to an area with the address 010100 and performs the third checking process thereon. If the area with the address 010100 turns out to be a recordable area after the third checking process, the drive proceeds to operation S522 and searches a fifth area. If the area with the address 010100 turns out to be a non-recordable area after the third checking process, the drive proceeds to operation S524 and checks a sixth area.

If the area with the address 011000 is a non-recordable area, the drive proceeds to operation S512, in which the drive moves to an area with the address 011100 for performing the third checking processing thereon. If the area having the address 011100 turns out to be a recordable area after the third checking process, the drive proceeds to operation S526 and searches a seventh area. On the other hand, if the area having the address 011100 turns out to be a non-recordable area after the third checking process, the drive proceeds to operation S528 and searches an eighth area.

Table 1 below lists the first to eighth areas and their allocated addresses.

TABLE 1

| Area | Area address |
|---|---|
| Area 1 | 000000-000100 |
| Area 2 | 000101-001000 |
| Area 3 | 001001-001100 |
| Area 4 | 001101-010000 |
| Area 5 | 010001-010100 |
| Area 6 | 010101-011000 |
| Area 7 | 011001-011100 |
| Area 8 | 011101-100000 |

The drive searches only the areas having addresses included in the area that is acquired through this particular three-part checking process. For instance, suppose a command is issued to the drive to search the first area only. Then, the drive searches areas having the addresses 000000 to 00100 only. Similarly, when the drive is to search the seventh area, it searches areas having the addresses 011001 to 011100 only.

By searching each area, the drive acquires in operation S530 an address corresponding to the boundary point between recordable areas and non-recordable areas.

According to the method in FIG. 5, the number of checking processes to be performed was predetermined. However, it is evident that the checking process can be repeated until the number of areas included in the first area to be smaller than a user-designated number.

In conclusion, an embodiment of the present invention suggests the method for quickly searching the boundary point between recordable areas and non-recordable areas in the PCA of the optical disc. That is, instead of searching sequentially from a specific point of the PCA area to the boundary point, the drive searches the boundary point by designated space unit (i.e., address space), so that the time spent loading the optical disc can be markedly reduced.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method for searching for a boundary point between at least one recordable area for recording data and at least one non-recordable area of a PCA (Power Calibration Area) in an optical disc, the method comprising:
in an optical disc drive, moving to a first point in the PCA, and checking whether the first point is a recordable or a non-recordable area;
in the optical disc drive, based on a result of the checking, moving to the right or left to a second point located in a first-designated space that varies by a movement count, and checking whether the second point is a recordable area or a non-recordable area; and
in the optical disc drive, repeating the moving and checking operation until a first non-recordable area adjacent to the recordable area is identified.

2. The method according to claim 1, wherein each area of the PCA is allocated with a unique address sequentially starting from non-recordable areas to recordable areas.

3. The method according to claim 2, wherein the non-recordable area is located inward of the PCA, and the recordable area is located outward of the PCA.

4. The method according to claim 1, wherein the first point is a midpoint of the PCA.

5. The method according to claim 4, wherein, if the first point is a recordable area the optical disc drive moves to the left to a second point located in a first designated space, whereas if the first point is a non-recordable area the optical disc drive moves to the right to a second point located in a second designated space.

6. The method according to claim 5, wherein the first designated space is inversely proportional to the movement count.

7. The method according to claim 1, wherein the movement count is predetermined, and the optical disc drive repeats the moving and checking operation only within the predetermined movement count.

8. The method according to claim 7, wherein, if the boundary point is not searched within the predetermined movement count, the optical disc drive sequentially searches areas from the second point to the second designated space.

9. A method comprising:
searching an initial location of a PCA (Power Calibration Area) for a boundary point between at least one recordable area and at least one non-recordable area of the PCA; and
if the boundary point is not found, designating at least one subsequent search location of the PCA based on a value relating to the initial location and the PCA.

10. The method of claim 9, wherein the initial location is a mid-point of the PCA.

11. The method of claim 9, wherein the value relating to the initial location and the PCA comprises a predetermined distance.

12. The method of claim 9, wherein the value relating to the initial location and the PCA comprises a predetermined count.

13. An apparatus comprising:
a searching part searching an initial location of a PCA (Power Calibration Area) for a boundary point between at least one recordable area and at least one non-recordable area of the PCA; and
a designator to, if the boundary point is not found, designate at least one subsequent search location of the PCA based on a value relating to the initial location and the PCA.

14. The apparatus of claim 13, wherein the designator, if the boundary point is not found, designates at least one more subsequent search location of the PCA based on a value relating to the subsequent search location and the PCA or the initial location.
